(19) United States
(12) Patent Application Publication
(10) Pub. No.: US 2021/0326761 A1
(43) Pub. Date: Oct. 21, 2021

(54) Method and System for Uniform Execution of Feature Extraction

(71) Applicant: THE FOURTH PARADIGM (BEIJING) TECH CO LTD, Beijing (CN)

(72) Inventors: Yajian HUANG, Beijing (CN); Taize WANG, Beijing (CN); Long DENG, Beijing (CN); Xiaoliang FAN, Beijing (CN); Chenlu LIU, Beijing (CN); Yongchao LIU, Beijing (CN); Di SUN, Beijing (CN)

(21) Appl. No.: 17/270,248

(22) PCT Filed: Aug. 20, 2019
(86) PCT No.: PCT/CN2019/101649

§ 371 Date: Feb. 22, 2021

(30) Foreign Application Priority Data
Aug. 21, 2018 (CN) 201810954494.5

(51) Int. Cl. G06N 20/00

(52) U.S. Cl. CPC G06N 20/00

(57) ABSTRACT

Provided is a method and system for uniform execution of feature extraction. The method comprises: acquiring a feature extraction script for defining a processing logic related to feature extraction; analyzing the feature extraction script to generate an execution plan for feature extraction; and executing the generated execution plan by a local machine or a cluster based on a feature extraction scene. Based on the method and system, feature extraction can be uniformly executed at various feature extraction scenes.

### TECHNICAL FIELD

The present disclosure generally relates to the field of data processing, in particular to a method and a system for uniform execution of feature extraction.

### BACKGROUND

With the emergence of “big data”, people are inclined to exploit value from data by employing a machine learning technique. Machine learning is an inevitable product as artificial intelligence research is developed to a certain stage and is committed to improving the performance of a system itself empirically by means of calculation. In a computer system, “experience” often exists in form of “data”. A “model” can be generated from data by means of a machine learning algorithm, i.e., provision of empirical data to the machine learning algorithm can generate the model based on these empirical data. In the face of new circumstances, corresponding prediction results are obtained by means of trained models. No matter whether in a stage of training the machine learning model or in a stage of estimating with the machine learning model, is necessary to perform feature extraction on data to obtain machine learning samples including various features.

A current machine learning platform or system primarily realizes a function of training a machine learning model, i.e., the platform or system performs processes of operations such as feature extraction, model building and model tuning by means of collected large-scale data. What is emphasized in this stage is not the response speed but the throughput capacity, i.e., data size processed within a unit time. If it is necessary to use a trained machine learning model to estimate, it is usually focused on the response speed rather than the throughput capacity, which urges technicians to perform additional development for the estimating stage, especially for a feature extraction process, leading to a higher estimating cost.

### SUMMARY

An exemplary embodiment of the disclosure provides a method and a system for uniform execution of feature extraction, and the method and system can be used for uniform execution of feature extraction in various feature extraction scenes.

According to the exemplary embodiment of the disclosure, a method for uniform execution of feature extraction is provided, wherein the method includes the steps of: acquiring a feature extraction script for defining a processing logic related to feature extraction; analyzing the feature extraction script to generate an execution plan for feature extraction; and executing the generated execution plan by a local machine or a cluster based on a feature extraction scene.

According to another exemplary embodiment of the disclosure, a system for uniform execution of feature extraction is provided, wherein the system includes: a script acquisition device for acquiring a feature extraction script for defining a processing logic related to feature extraction; a plan generation device for analyzing the feature extraction script to generate an execution plan for feature extraction; and a plan execution device for executing the generated execution plan by a local machine or a cluster based on a feature extraction scene.

According to another exemplary embodiment of the disclosure, a system including at least one calculating device and at least one storing device that stores a command is provided, wherein the command enables the at least one calculating device to execute the method of uniform execution of feature extraction when being operated by the at least one calculating device.

According to another exemplary embodiment of the disclosure, a computer readable storage medium that stores the command is provided, wherein the command enables the at least one calculating device to execute the method for uniform execution of feature extraction when being operated by the at least one calculating device.

The method and system for uniform execution of feature extraction according to the exemplary embodiment of the disclosure can be used for uniform execution of feature extraction in various feature extraction scenes. As an example, on the one hand, the method and system can be compatible with an online feature extraction scene and an offline feature extraction scene to achieve seamless joint of the online feature extraction scene and the offline feature extraction scene, so that it is unnecessary to develop specific operating modes in the online feature extraction scene and the offline feature extraction scene separately for the same feature extraction script, and therefore, the workload of development staff is reduced; and on the other hand, the method and system can be used for feature extraction efficiently by way of a high throughput in the offline feature extraction scene, and moreover, the method and system can be used for feature extraction with high real-time and low time delay in the online feature extraction scene. In addition, the method and system can be compatible with both time-sequence feature extraction and non-time-sequence feature extraction.

Further aspects and/or advantages of general plotting of the disclosure will be illustrated partially in the following description. A further part is apparent from the description or can be learned through embodiments of the general idea of the disclosure.

### BRIEF DESCRIPTION OF THE DRAWINGS

Description will be made below in combination with drawings exemplarily illustrating the embodiments, and the above and other purposes and characteristics of the exemplary embodiments of the disclosure will become more apparent. In the drawings,

FIG. 1 illustrates a flow diagram of the method for uniform execution of feature extraction according to the exemplary embodiment of the disclosure;

FIG. 2 illustrates an example of execution plan according to the exemplary embodiment of the disclosure;

FIG. 3 illustrates a flow diagram of the method for uniform execution of feature extraction according to another exemplary embodiment of the disclosure; and

FIG. 4 illustrates a block diagram of the system for uniform execution of feature extraction according to the exemplary embodiment of the disclosure.

### DETAILED DESCRIPTION

Detailed reference will be now made to the embodiments of the disclosure and examples of the embodiments are illustrated in the drawings, wherein same labels refer to same parts consistently. Description of the embodiments will be made with reference to the drawings below for the convenience of explaining the disclosure. It should be noted that both “and/or” and “additionally/alternatively” in the disclosure represent three parallel cases. For example, “including A and/or B” represents including at least one of A and B, i.e., including the following three parallel conditions: (1) including A; (2) including B; and (3) including both A and B. Similarly, “including A, B and/or C” represents including at least one of A, B and C. In another example, “executing step 1 and/or step 2” represents executing at least one of step 1 and step 2, i.e., represents the following three parallel cases: (1) executing step 1; (2) executing step 2; and (3) executing both step 1 and step 2.

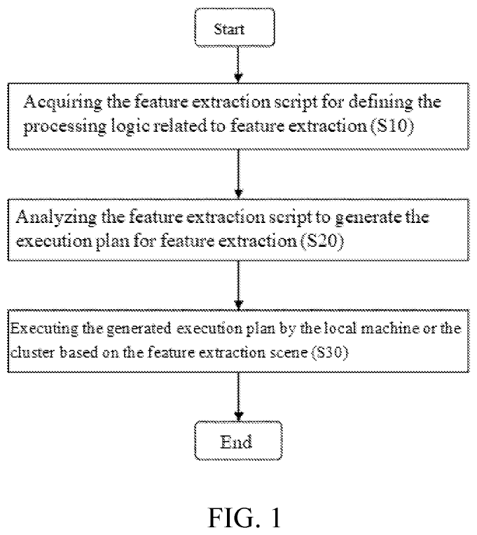

FIG. 1 illustrates the flow diagram of the method for uniform execution of feature extraction according to the exemplary embodiment of the disclosure. As an example herein, the method can be executed by either a computer program or an aggregation of dedicated hardware equipment or software and hardware resources for executing machine learning, big data calculation or data analysis. For example, the method can be executed by a machine learning platform for implementing machine learning related businesses.

With reference to the FIG. 1, in the step S10, a feature extraction script for defining a processing logic related to feature extraction is acquired.

The processing logic related to feature extraction herein can include any processing logic related to feature extraction. As an example, the processing logic related to feature extraction can include a processing logic that acquires features from a data table. The data table herein can be either an original data table or a data table acquired by processing the original data table (for example, splicing a plurality of original data tables).

As an example, when the data table is the data table that is acquired by splicing the plurality of original data tables, the processing logic related to feature extraction can further include a processing logic for splicing the data tables. As a preferred example, the processing logic for splicing the data tables can include a processing logic for splicing the data tables for source fields of features. The processing logic for splicing the data tables for original fields of features herein is a processing logic for only splicing the source fields of features in the to-be-spliced data tables to form a new data table.

Each data record in the data table herein can be regarded as description with respect to one event or object, corresponding to one example or sample. In the data record, attribute information reflecting representation or property of the event or object in a certain aspect is included, namely, the field. For example, one row of the data table corresponds to one data record and one column of the data table corresponds to one field.

As an example, the processing logic related to feature extraction can relate to feature extraction in one or more time windows. The time windows herein can be used for screening one or more data records needed to depend when features are generated, wherein the time windows can be used for generating non-time-sequence features when being set to only include one data record and can be used for generating time-sequence features when being set to include more data records. It should be understood that the processing logic related to feature extraction can relate to extraction of one or more features in each time window. As an example, when the processing logic related to feature extraction relates to feature extraction in more time windows, the processing logic related to feature extraction can further include a processing logic for summarizing the features.

As an example, the time window is defined by at least one of a source data table, a segmentation reference field, a time reference field, a time span and a window size. Specifically, the source data table of the time window is the data table, wherein feature extraction is based on the data table in the time window. A segmentation reference field of the time window is a field (for example, a user ID), wherein the data records in the source data table are grouped (i.e., fragmented) based on the field. A time reference field of the time window is a field (for example, a user card-swiping time), wherein each group of the data records is sequenced based on the field. The time span of the time window is a time range (for example, a week) corresponding to the time reference field of the data record in the time window, the window size of the time window is quantity of data in the time window, and the window size is an integer that is greater than 0. It should be understood that either one of the time span and the window size or both the time span and the window size can be set in defining the time window.

As an example, when the processing logic related to feature extraction relates to feature extraction in more time windows, the more time windows are different one another, i.e., at least one of the following items among the more time windows is different: source data table, segmentation reference field, time reference field, time span and window size.

As an example, the processing logic related to feature extraction can relate to: non-time-sequence feature extraction in the time window with the window size being 1, and/or time-sequence feature extraction in the time window with the window size not being 1.

With respect to time-sequence feature extraction, it is necessary to perform time-sequence feature extraction generally in processing time-sequence data. The time-sequence data is of very high sequentiality and previous and later data are generally in dependent, periodical relationships and the like. For example, transaction data can present time-varying strong correlation, and thus, a statistical result of the transaction data can be regarded as a feature of the sample. Therefore, features (for example, recent transaction habits (such as amount) and the like) that reflect time-sequence behaviors can be generated based on the time windows. It is generally necessary to appoint dimensionality (i.e., the segmentation reference fields of the time windows) of the time-sequence data, for example, whether related features (for example, time-sequence statistical features related to transaction amount) are extracted according to a natural person (for example, the user ID) or related features are extracted according to a card number with transactions. In addition, it is further necessary to appoint a range (i.e., the time spans and/or the window sizes of the time windows) of historical data related to the time-sequence features, for example, the transaction amount with the latest week and the like. The time windows corresponding to extraction of the time features can specify all data records (including current data records and/or historical data records), wherein current to-be-extracted features are dependent on the data records, so that the current to-be-extracted features can be calculated based on related field values in these data records.

According to the exemplary embodiments of the disclosure, non-time-sequence feature extraction in the time window with the window size being 1 can be considered, so that extraction of both time-sequence features and non-time-sequence features can be compatible by means of uniform time window setting. However, in the exemplary embodiments of the present disclosure, it should be understood that non-time-sequence feature extraction may be performed without being in the time window.

As an example, when the processing logic related to feature extraction only relates to non-time-sequence feature extraction, it is possible that the processing logic related to feature extraction is not involved with any time window, i.e., it is unnecessary to provide any time window for extracting features.

As an example, when the processing logic related to feature extraction relates to both non-time-sequence feature extraction and time-sequence feature extraction, the processing logic related to feature extraction may involve: non-time-sequence feature extraction in the time window with the window size being 1, and time-sequence feature extraction in the time window with the window size not being

As an example, a feature extraction script for defining the processing logic related to feature extraction can be acquired directly and externally. As another example, the feature extraction script can be acquired based on a code for defining the processing logic related to feature extraction, which is input by a user through an input box, and/or based on a configuration item, for defining the processing logic related to feature extraction, which is configured by a user. For example, the method can be executed by the machine learning platform for executing a machine learning process, and the machine learning platform can respond to a user operation to provide a graphical interface (for example, an interface for configuring feature engineering) for configuring a feature extraction process, wherein the graphical interface can include an input control for inputting the processing logic related to feature extraction, and then can receive an input operation of the user of executing the input control on the graphical interface and acquire the feature extraction script for defining the processing logic related to feature extraction according to the input operation. As an example, the input control can include a content input box for inputting the code and/or the configuration item for defining the processing logic related to feature extraction and/or a selection control for performing a selecting operation among candidate configuration items with respect to the processing logic related to feature extraction.

In the step S20, the acquired feature extraction script is analyzed to generate the execution plan for feature extraction.

As an example, the processing logic defined by the feature extraction script can be segmented according to a processing sequence to generate the execution plan for feature extraction. As it is necessary to execute the feature extraction process according to a certain processing sequence, for example, processing such as splicing the data tables, acquiring features from the data tables and summarizing the generated features is required in the feature extraction process, the processing logic defined by the acquired feature extraction script can be segmented according to the processing sequence of the feature extraction process, for example, the processing logic defined by the acquired feature extraction script can be segmented into a processing logic part for splicing the data tables, a processing logic part for acquiring features from the data tables and a processing logic part for summarizing the generated features. Then, the executing plan for feature extraction can be generated based on each the segmented processing logic part.

As an example, corresponding processing logic can be segmented according to the processing sequence to generate the execution plan for feature extraction for each time window when the acquired processing logic defined by the feature extraction script relates to feature extraction in at least one time window. That is, the processing logics corresponding to different time windows are not segmented into the same processing logic part. For example, corresponding processing logic corresponding to the time window can be segmented according to the processing sequence of the feature extraction process for each time window when the acquired processing logic defined by the feature extraction script relates to feature extraction in the more time windows. For example, the acquired processing logic defined by the acquired feature extraction script can be segmented into the processing logic part for splicing the data tables for each time window, the processing logic part for acquiring features from the data tables and the processing logic part for summarizing the generated features generated by all the time windows. Then, the executing plan for feature extraction can be generated based on each the segmented processing logic part.

As an example, the generated executing plan for feature extraction can be a directed acyclic graph constituted by nodes, wherein the nodes correspond to the segmented processing logics. As an example, the nodes include calculation nodes corresponding to the processing logics for acquiring features from the data tables. Further, the nodes can further include table splicing nodes corresponding to the processing logics for splicing the data tables, and/or feature splicing nodes corresponding to the processing logics for summarizing the features. As an example, the processing logics for acquiring the features from the data tables for different time windows can correspond to different calculation nodes, and the processing logics for splicing different data tables can correspond to different table splicing nodes. It should be understood that a connecting relationship with the nodes corresponding to each segmented processing logic part can be determined based on a relationship between an input variable and/or an output variable of each segmented processing logic part.

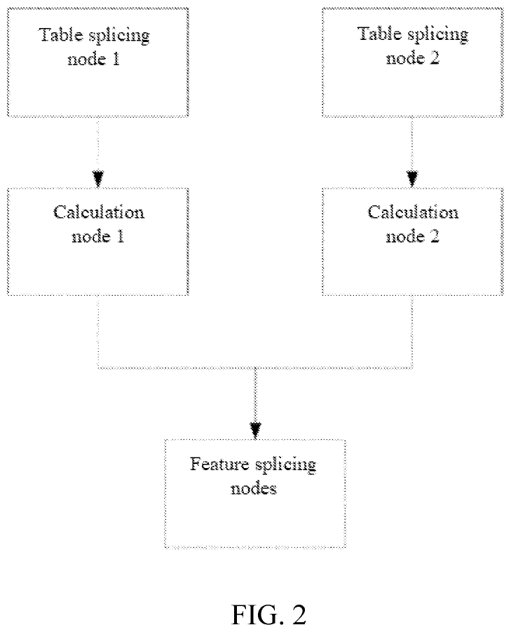

FIG. 2 illustrates an example of execution plan according to the exemplary embodiment of the disclosure. As shown in the FIG. 2, the processing logic defined by the acquired feature extraction script can be segmented according to the processing sequence of the feature extraction process as follows: the processing logic part for splicing the data tables for the time window 1 (for example, the processing logic part for splicing the data table 1 and the data table 2 to acquire a source data table of the time window 1), the processing logic part for acquiring the features (executing feature extraction) from the data tables for the time window 1, the processing logic part for splicing the data tables for the time window 2 (for example, the processing logic part for splicing the data table 1 and the data table 3 to acquire the source data table of the time window 2), the processing logic part for acquiring the features from the data tables for the time window 2 and the processing logic part for summarizing the features acquired based on the time window 1 and the features acquired based on the time window 2. Then, the directed acyclic graph formed by the nodes shown in the FIG. 2 can be generated based on each segmented processing logic part (i.e. the execution plan for feature extraction), wherein the table splicing node 1 corresponds to the processing logic part for splicing the data tables for the time window 1, the calculating node 1 corresponds to the processing logic part for acquiring the features from the data tables for the time window 1, the table splicing node 2 corresponds to the processing logic part for splicing the data tables for the time window 2, the calculating node 2 corresponds to the processing logic part for acquiring the features from the data tables for the time window 2 and a feature splicing node corresponds to the processing logic part for summarizing the features acquired based on the time window 1 and the features acquired based on the time window 2.

Referring back to the FIG. 1, in the step S30, the generated execution plan is executed by the local machine or the cluster based on the feature extraction scene. As an example, the feature extraction scene can be the online feature extraction scene or the offline feature extraction scene.

As an example, when the generated execution plan is the directed acyclic graph formed by the nodes, the processing logic corresponding to each node is implemented by the local machine or the cluster so as to execute the generated execution plan according to the connecting relationship among the nodes in the directed acyclic graph based on the feature extraction scene.

As an example, implementing the processing logic corresponding to the calculating node by the local machine or the cluster can include directly operating the calculating node by the local machine or the cluster. As another example, implementing the processing logic corresponding to the calculating node by the local machine or the cluster can include compiling the processing logic corresponding to the calculating node into at least one executable file by the local machine or the cluster and operating the at least one executable file. Preferably, corresponding optimization can be performed when the processing logic is compiled into the executable file.

As a preferred example, in the process of compiling the processing logic corresponding to the calculating node into the executable file, a common subexpression in the processing logic can be replaced with an intermediate variable. For example, when the processing logic corresponding to the calculating node includes f1=discrete(max(col1)) and f2=continous(max(col1)), the common subexpression max(col1) can be taken as the intermediate variable in the process of compiling the processing logic corresponding to the calculating node into the executable file, i.e., ordering a=max(col1), f1=discrete(a) and f2=continous(a), thus, it is necessary to calculate value of a once when the corresponding executable file is executed and f1 and f2 can reuse a calculating result of a. Reuse of the intermediate calculating result can be implemented by reusing the intermediate variable, so that the calculating amount of the feature extraction process can be reduced and the executing efficiency of the feature extraction process can be improved.

As a preferred example, in the process of compiling the processing logic corresponding to the calculating node into the executable file, part of processing logics that are closely related in operation and independent from other processing logics among the processing logics can be compiled into the same executable file. For example, the part of processing logics that are closely related in operation and independent from other processing logics among the processing logics can be part of processing logics that use the same common subexpression and are not associated with other processing logics in logic. Thus, the part of processing logics can share the intermediate variable, and moreover, as different executable files do not share the intermediate variable, the different executable files can be executed in parallel. Therefore, according to the method, a JIT (Just-In-Time, In-time compiling) of a compiler can be reused, so that the executing efficiency of the code in the compiled executable file is improved, and logic isolation can be prepared for parallel execution of the feature extraction process so as to execute the plurality of executable files in parallel.

As an example, for each calculating node, the processing logic corresponding to the calculating node is compiled into at least one executable file.

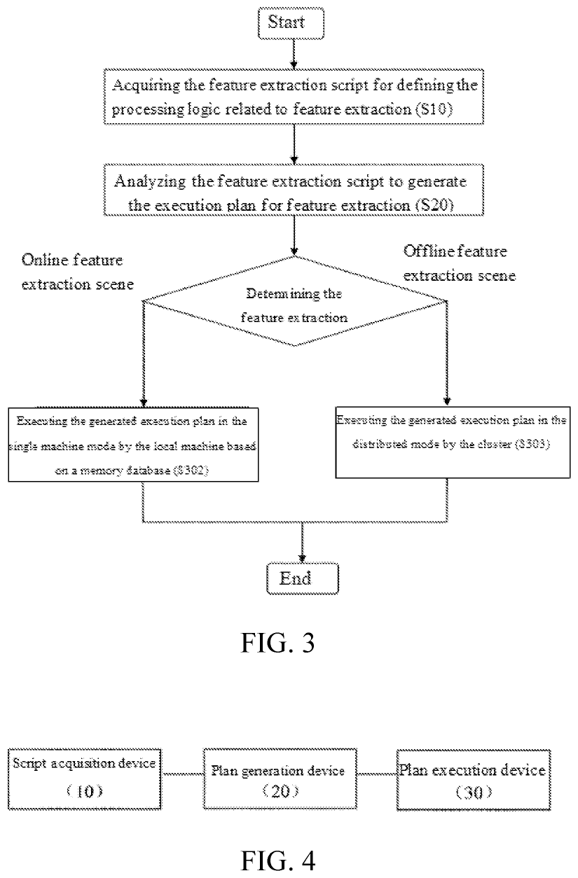

FIG. 3 illustrates a flow diagram of the method for uniform execution of feature extraction according to another exemplary embodiment of the disclosure. The S30 herein specifically comprises S301, 5302 and S303. S10 and S20 can be implemented with reference to the embodiments described in the FIG. 1 and FIG. 2, and no more detailed description is made herein.

In the step S301, the feature extraction scene is determined.

As an example, the feature extraction scene specified by the user can be acquired. For example, the method can be executed by the machine learning platform for executing a machine learning process, and the machine learning platform can provide the graphical interface for specifying the feature extraction scene to the user so as to acquire the feature extraction scene specified by the user according to the input operation, executed by the graphical interface, of the user.

As another example, the feature extraction scene can be determined automatically. For example, when the current machine learning scene is a machine learning scene in a training machine learning mod, the feature extraction scene can be determined as the offline feature extraction scene automatically, and when the current machine learning scene is a machine learning scene estimated by the trained machine learning model, the feature extraction scene can be determined as the online feature extraction scene automatically.

When the feature extraction scene determined in the step S301 is the online feature extraction scene, the generated execution plan is executed in a local machine in a single machine mode. As an example, the generated execution plan can be executed in the single machine mode by the local machine based on an internal memory database. For example, the processing logic for splicing the data tables and/or the processing logic for summarizing the features can be implemented by the internal memory database of the local machine.

When the feature extraction scene determined in the step S301 is the online feature extraction scene, the generated execution plan is executed in a distributed mode by the cluster. In other words, the generated execution plan can be executed by a plurality of calculating devices in the cluster. It should be noted that the calculating devices described herein can indicate either physical entities or virtual entities, for example, the calculating devices can indicate actual calculating machines or logic entities deployed on the calculating machines.

As an example, the generated execution plan can b executed in the distributed mode by the cluster based on a parallel operational framework Spark. For example, the processing logics such as the processing logic for splicing the data tables and summarizing the features can be implemented by a bottom interface of the Spark. For example, the generated execution plan for feature extraction can be distributed to each calculating device in the cluster based on the Spark to enable each calculating device to execute the generated execution plan based on data stored therein and return the execution result. In addition, the generated execution plan further can be executed in the distributed mode by the cluster based on other parallel operational frameworks.

As an example, the S303 can include providing a list of candidate clusters to the user; and executing the generated execution plan in the distributed mode by the clusters selected by the user from the list.

The method for uniform execution of feature extraction according to the exemplary embodiment of the disclosure can be used for executing the uniform execution plan by the local machine or the cluster according to the feature extraction scene for the same feature extraction script. As an example, in the online feature extraction scene, the generated execution plan is executed by the local machine and in the offline feature extraction scene, the generated execution plan is executed by the cluster. On the one hand, the method can be compatible with the online feature extraction scene and the offline feature extraction scene to achieve seamless joint of the online feature extraction scene and the offline feature extraction scene, so that it is unnecessary to develop specific operating modes in the online feature extraction scene and the offline feature extraction scene separately for the same feature extraction script, and the workload of development staff is reduced; and on the other hand, the method can be used for feature extraction efficiently by way of a high throughput in the offline feature extraction scene, and moreover, the method and system can be used for feature extraction with high real-time and low time delay in the online feature extraction scene.

As an example, the S303 can include implementing the processing logic corresponding to the calculating node for feature extraction in the time window by executing the following operations in the distributed mode by the cluster: dividing data records with a same segmentation reference field value in the source data table of the time window into a same group (i.e., different groups correspond to different segmentation reference field values) and sequencing the data records in the same group according to an increasing sequence (i.e., the time-sequence corresponding to the time reference field values) of the time reference field values; and then performing feature extraction in the time window based on the sequenced data records in the same group, specifically, for the current data records, processing values of source fields on which each feature depends on to acquire each feature, wherein each data record in the time window is screened from corresponding group according to time span and/or window size.

As an example, the S302 can include implementing the processing logic corresponding to the calculating node for feature extraction in the time window by executing the following operations in the single machine mode by the local machine: for the current data records, processing values of source fields on which each feature depends on to acquire each feature by means of each data record in the corresponding time window, wherein each data record in the time window is screened from corresponding group according to time span and/or window size.

FIG. 4 illustrates a block diagram of the system for uniform execution of feature extraction according to the exemplary embodiment of the disclosure. As shown in the FIG. 4, the system for uniform execution of feature extraction according to the exemplary embodiment of the disclosure includes a script acquisition device 10, a plan generation device 20 and a plan execution device 30.

Specifically, the script acquisition device 10 is used for acquiring the feature extraction script for defining the processing logic related to feature extraction.

The processing logic related to feature extraction herein can include any processing logic related to feature extraction. As an example, the processing logic related to feature extraction can include processing logic that acquires features from a data table. The data table herein can be either an original data table or a data table acquired by processing the original data table (for example, splicing a plurality of original data tables).

As an example, when the data table is the data table that is acquired by splicing the plurality of original data tables, the processing logic related to feature extraction can further include processing logic for splicing the data tables. As a preferred example, the processing logic for splicing the data tables can include a processing logic for splicing the data tables for source fields of features. The processing logic for splicing the data tables for original fields of features herein is a processing logic for only splicing the source fields of features in the to-be-spliced data tables to form a new data table.

As an example, the processing logic related to feature extraction can relate to feature extraction in one or more time windows. The time windows herein can be used for screening one or more data records needed to depend when features are generated, wherein the time windows can be used for generating non-time-sequence features when being set to only include one data record and can be used for generating time-sequence features when being set to include more data records. It should be understood that the processing logic related to feature extraction can relate to extraction of one or more features in each time window. As an example, when the processing logic related to feature extraction relates to feature extraction in more time windows, the processing logic related to feature extraction can further include a processing logic for summarizing the features.

As an example, the time window is defined by at least one of a source data table, a segmentation reference field, a time reference field, a time span and a window size. Specifically, the source data table of the time window is the data table, wherein feature extraction is based on the data table in the time window. A segmentation reference field of the time window is a field (for example, a user ID), wherein the data records in the source data table are grouped (i.e., fragmented) based on the field. A time reference field of the time window is a field (for example, a user card-swiping time), wherein each group of the data records is sequenced based on the field. The time span of the time window is a time range (for example, a week) corresponding to the time reference field of the data record in the time window, the window size of the time window is quantity of data in the time window, and the window size is an integer that is greater than 0. It should be understood that either one of the time span and the window size or both the time span and the window size can be set in defining the time window.

As an example, when the processing logic related to feature extraction relates to feature extraction in more time windows, the more time windows are different one another, i.e., at least one of the following items among the more time windows is different: source data table, segmentation reference field, time reference field, time span and window size.

As an example, the processing logic related to feature extraction can relate to: non-time-sequence feature extraction in the time window with the window size being 1, and time-sequence feature extraction in the time window with the window size not being 1.

As an example, the script acquisition device 10 can be used for acquiring the feature extraction script for defining the processing logic related to feature extraction directly externally. As another example, the script acquisition device 10 can be used for acquiring the feature extraction script based on a code, for defining the processing logic related to feature extraction, input by a user through an input box and/or a configuration item, for defining the processing logic related to feature extraction, configured by a user.

The plan generation device 20 is used for analyzing the feature extraction script to generate the execution plan for feature extraction.

As an example, the plan generation device 20 can be used for segmenting a processing logic defined by the feature extraction script according to a processing sequence to generate the execution plan for feature extraction.

As an example, the plan generation device 20 can be used for segmenting corresponding processing logic according to the processing sequence to generate the execution plan for feature extraction for each time window when the processing logic relates to feature extraction in at least one time window.

As an example, the generated executing plan for feature extraction can be a directed acyclic graph constituted by nodes, wherein the nodes correspond to the segmented processing logics. As an example, the nodes include calculation nodes corresponding to the processing logics for acquiring features from the data tables. Further, the nodes can further include table splicing nodes corresponding to the processing logics for splicing the data tables, and/or feature splicing nodes corresponding to the processing logics for summarizing the features. As an example, the processing logics for acquiring the features from the data tables for different time windows can correspond to different calculation nodes, and the processing logics for splicing different data tables can correspond to different table splicing nodes. It should be understood that a connecting relationship with the nodes corresponding to each segmented processing logic part can be determined based on a relationship between an input variable and/or an output variable of each segmented processing logic part.

The plan execution device 30 is used for executing the generated execution plan by the local machine or the cluster based on the feature extraction scene. As an example, the feature extraction scene can be the online feature extraction scene or the offline feature extraction scene.

As an example, the plan execution device 30 can acquire the feature extraction scene specified by the user. For example, the system can be deployed on the machine learning platform for executing the machine learning process, and a display device can provide the graphical interface for specifying the feature extraction scene to the user, and the plan execution device 30 can acquire the feature extraction scene specified by the user according to the input operation, executed by the graphical interface, of the user.

As another example, the plan execution device 30 can determine the feature extraction scene automatically. For example, when the current machine learning scene is a machine learning scene in a training machine learning mod, the plan execution device 30 can determine the feature extraction scene as the offline feature extraction scene automatically, and when the current machine learning scene is a machine learning scene estimated by the trained machine learning model, the plan execution device 30 can determine the feature extraction scene as the online feature extraction scene automatically.

As an example, when the feature extraction scene is the online feature extraction scene, the plan execution device 30 can execute the generated execution plan in the single machine mode by the local machine. As an example, the system can be deployed on the machine learning platform for executing the machine learning process, and the local machine is the current calculating device that uses the machine learning platform for feature extraction.

As an example, when the feature extraction scene is the online feature extraction scene, the plan execution device 30 can execute the generated execution plan in the distributed machine mode by the cluster.

As an example, the plan execution device 30 can execute the generated execution plan in the distributed mode by the cluster based on a parallel operational framework Spark.

As an example, when the execution plan is the directed acyclic graph formed by the nodes, the plan execution device 30 can implement the processing logic corresponding to each node by the local machine or the cluster so as to execute the generated execution plan based on the feature extraction scene.

As another example, the plan execution device 30 can compile the processing logic corresponding to the calculating node by the local machine or the cluster into at least one executable file by the local machine or the cluster and operate the at least one executable file. Preferably, the plan execution device 30 can perform corresponding optimization when compiling the executable file.

As an example, in the process of compiling the processing logic corresponding to the calculating node into the executable file, the plan execution device 30 can replace a common subexpression in the processing logic with an intermediate variable.

As an example, in the process of compiling the processing logic corresponding to the calculating node into the executable file, the plan execution device 30 can compile part of processing logics that are closely related in operation and independent from other processing logics among the processing logics into the same executable file.

As an example, the plan execution device 30 can provide a list of candidate clusters to the user when the feature extraction scene is the offline feature extraction scene and execute the generated execution plan in the distributed mode by means of clusters selected by the user from the list.

It should be understood that the embodiments of the system for uniform execution of feature extraction according to the exemplary embodiment of the disclosure can be implemented with reference to related embodiments described in FIG. 1 to FIG. 3, and no more detailed description is made herein.

The devices included by the system for uniform execution of feature extraction according to the exemplary embodiment of the disclosure can be separately configured to software, hardware, firmware for executing specific functions and any combination thereof. For example, these devices can be corresponding to either a special integrated circuit or a pure software cord and a module where software and hardware are combined. In addition, one or more functions implemented by these devices can be further executed by assemblies in physical entity equipment (for example, a processor, a client or a server and etc.) uniformly.

It should be understood that the method for uniform execution of feature extraction according to the exemplary embodiment of the disclosure can be implemented by a program recorded on the computer readable medium, for example, the computer readable medium for uniform execution of feature extraction can be provided according to the exemplary embodiment of the disclosure, wherein the computer program for executing the following methods is recorded on the computer readable medium: acquiring the feature extraction script for defining the processing logic related to feature extraction; analyzing the feature extraction script to generate the execution plan for feature extraction; and executing the generated execution plan by the local machine or the cluster based on the feature extraction scene.

The computer program in the computer readable medium can operate in an environment where computer equipment such as the client, a main frame, an agent device and the server are deployed. It should be noted that the computer program further can be used for executing additional steps besides the steps or executing more specific processing when executing the steps. These additional steps and further processed contents have been described with reference to FIG. 1 to FIG. 3. In order to avoid repetition, no more detailed description is made.

It should be noted that the method for uniform execution of feature extraction according to the exemplary embodiment of the disclosure can implement corresponding functions dependent on operation of the computer program completely, i.e., each device corresponds to each step in a functional architecture of the computer program, so that the whole system is transferred by a special software pack (for example, a lib) to implement the corresponding functions.

On the other hand, the devices included by the system for uniform execution of feature extraction according to the exemplary embodiment of the disclosure can be further implemented by means of hardware, software, firmware, middleware, a microcode or any combination thereof. When the method is implemented by means of hardware, software, firmware, middleware and the microcode, a program code or a code segment for executing a corresponding operation can be stored in the computer readable medium such as a storage medium, so that the processor can execute the corresponding operation by reading and operating the corresponding program code or code segment.

For example, the exemplary embodiment of the disclosure can be further implemented as the calculating device. The calculating device comprises a storage part and a processor. The storage part stores a computer executable command set. When the computer executable command set is executed by the processor, the method for executing feature extraction is executed uniformly.

Specifically, the calculating device can be either deployed in the server or the client or in a node device in a distributed network environment. In addition, the calculating device can be a PC, a tablet personal computer device, a personal digital assistant, a smart phone, a web application or other devices capable of executing the command set.

The calculating device herein is not necessarily a single calculating device and can be any aggregation of devices or circuits capable of executing the command (or command set) independently or jointly. The calculating device further can be a part of an integrated control system or a system manager or can be configured as portable electronic device interconnected locally or remotely (for example, through wireless transmission) by an interface.

In the calculating device, the processor can include a central processing unit (CPU), a graphics processing unit (GPU), a programmable logic device, a dedicated processor system, a micro controller or a microprocessor. By way of example, and not limitation, the processor further can include an analog processor, a digital processor, a microprocessor, a multi-core processor, a processor array, a network processor and the like.

Some operations described in the method for uniform execution of feature extraction according to the exemplary embodiment of the disclosure can be implemented by way of software and some operation can be implemented by way of hardware. In addition, these operations can be further implemented by way of combining software with hardware.

The processor can operate the command or the code stored in one of storage parts, wherein the storage parts further can store data. Commands and data further can be sent and received by a network through a network interface device, wherein the network interface device can adopt any known transmission protocols.

The storage part can be integrated with the processor integrally, for example, an RAM or a flash memory is arranged in the microprocessor of the integrated circuit and the like. In addition, the storage part can include an independent device such as other storage devices capable of being used by an external drive, a storage array or any database system. The storage part and the processor can be coupled in operation or can intercommunicate through, for example, an I/O port, network connection and the like, so that the processor can read files stored in the storage part.

In addition, the calculating device further can include a video display (such as a liquid crystal display) and a user interaction interface (such as a keyboard, a mouse and a touch input device). All assemblies of the calculating device can be connected to each other via a bus and/or a network.

Operations involved in the method for uniform execution of feature extraction according to the exemplary embodiment of the disclosure can be described as various functional blocks or functional diagrams that are interconnected or coupled. However, these functional blocks or functional diagrams can be equably integrated as a single logic device or can be operated according to a unspecific boundary.

For example, as described above, the calculating device for uniform execution of feature extraction according to the exemplary embodiment of the disclosure can include the storage part and the processor, wherein the storage part stores a computer executable command set. When the computer executable command set is executed by the processor, The steps of acquiring the feature extraction script for defining the processing logic related to feature extraction; analyzing the feature extraction script to generate the execution plan for feature extraction; and executing the generated execution plan by the local machine or the cluster based on the feature extraction scene are executed.

Although exemplary embodiments of the disclosure are described above, it should be understood that the above description is intended to be exemplary only, rather than exhaustive; the present disclosure is not limited to the disclosed exemplary embodiments. Various modifications and variations will be apparent to those of ordinary skill in the art without departing from the scope and spirit of the disclosure. Therefore, the protection scope of the disclosure is subject to the protection scope of the accompanying claims.

1. A method for uniform execution of feature extraction by at least one calculating device, comprising:
acquiring a feature extraction script for defining a processing logic related to feature extraction;
analyzing the feature extraction script to generate an execution plan for feature extraction; and
executing the generated execution plan by a local machine or a cluster based on a feature extraction scene.

2. The method of claim 1, wherein the step of executing the generated execution plan by the local machine or the cluster based on the feature extraction scene comprises:
executing the generated execution plan in a standalone mode by the local machine when the feature extraction scene is an online feature extraction scene; and
executing the generated execution plan in a distributed mode by the cluster when the feature extraction scene is an offline feature extraction scene.

3. The method of claim 1, wherein the step of analyzing the feature extraction script to generate the execution plan for feature extraction comprises:
segmenting a processing logic defined by the feature extraction script according to a processing sequence to generate the execution plan for feature extraction.

4. The method of claim 3, wherein the processing logic relates to feature extraction in at least one time window, and
the step of segmenting the processing logic defined by the feature extraction script according to the processing sequence to generate the execution plan for feature extraction comprises: for each time window, segmenting a corresponding processing logic according to the processing sequence separately to generate the execution plan for feature extraction:
wherein the time window is defined by at least one of a source data table, a segmentation reference field, a time reference field, a time span and a window size;
wherein the processing logics relate to at least one of the following:
non-time-sequence feature extraction in the time window with the window size being 1, and
time-sequence feature extraction in the time window with the window size not being 1.

5. The method of claim 4, wherein the execution plan is a directed acyclic graph constituted by nodes, and wherein the nodes correspond to the segmented processing logics, and
the step of executing the generated execution plan by the local machine or the cluster based on the feature extraction scene comprises: implementing the processing logic corresponding to each of the nodes by the local machine or the cluster so as to execute the generated execution plan based on the feature extraction scene;
wherein the nodes comprise calculation nodes corresponding to the processing logics for acquiring features from a data table;
wherein the nodes further comprise at least one of table splicing nodes corresponding to the processing logics for splicing the data table, and feature splicing nodes corresponding to the processing logics for summarizing the features; and
wherein the processing logics for splicing the data table comprise processing logics for splicing the data table for the source fields of features.

6-7. (canceled).

8. The method of claim 5, wherein implementing the processing logics corresponding to the calculation nodes by the local machine or the cluster comprises:
compiling the processing logics corresponding to the calculation nodes into at least one executable file by the local machine or the cluster and operating the at least one executable file, and
wherein implementing the processing logics corresponding to the calculation nodes by the local machine or the cluster comprises at least one of following two steps: replacing a common subexpression in the processing logics with an intermediate variable in the process of compiling the processing logics corresponding to the calculation nodes into the executable file; and compiling part of processing logics that are closely related in operation and independent from other processing logics among the processing logics into the same executable file.

9. (canceled).

10. The method of claim 1, wherein the feature extraction scene is specified by a user or is determined automatically.

11. The method of claim 2, wherein the step of executing the generated execution plan in the distributed mode by the cluster when the feature extraction scene is the offline feature extraction scene comprises:
providing a list of candidate clusters to the user when the feature extraction scene is the offline feature extraction scene; and
executing the generated execution plan in the distributed mode by means of clusters selected by the user from the list.

12-13. (canceled).

14. A system comprising at least one calculating device and at least one storing device that stores a command, wherein the command enables the at least one calculating device to execute the following steps for uniform execution of feature extraction when being operated by the at least one calculating device:
acquiring a feature extraction script for defining a processing logic related to feature extraction;
analyzing the feature extraction script to generate an execution plan for feature extraction; and
executing the generated execution plan by a local machine or a cluster based on a feature extraction scene.

15. The system of claim 14, wherein the step of executing the generated execution plan by the local machine or the cluster based on the feature extraction scene comprises:
executing the generated execution plan in a standalone mode by the local machine when the feature extraction scene is an online feature extraction scene; and
executing the generated execution plan in a distributed mode by the cluster when the feature extraction scene is an offline feature extraction scene.

16. The system of claim 14, wherein the step of analyzing the feature extraction script to generate the execution plan for feature extraction comprises:
segmenting a processing logic defined by the feature extraction script according to a processing sequence to generate the execution plan for feature extraction.

17. The system of claim 16, wherein the processing logic relates to feature extraction in at least one time window, and
the step of segmenting the processing logic defined by the feature extraction script according to a processing sequence to generate the execution plan for feature extraction comprises: for each time window, segmenting a corresponding processing logic according to the processing sequence separately to generate the execution plan for feature extraction:
wherein the time window is defined by at least one of a source data table, a segmentation reference field, a time reference field, a time span and a window size:
wherein the processing logics relate to at least one of the following:
non-time-sequence feature extraction in the time window with the window size being 1, and
time-sequence feature extraction in the time window with the window size not being 1.

18. The system of claim 17, wherein the execution plan is a directed acyclic graph constituted by nodes, and wherein the nodes correspond to the segmented processing logics, and
the step of executing the generated execution plan by the local machine or the cluster based on the feature extraction scene comprises: implementing the processing logics corresponding to each of the nodes by the local machine or the cluster so as to execute the generated execution plan based on the feature extraction scene.

19. The system of claim 18, wherein the nodes comprise calculation nodes corresponding to the processing logics for acquiring features from a data table.

20. The system of claim 19, wherein the nodes further comprise at least one of table splicing nodes corresponding to the processing logics for splicing the data tables, and feature splicing nodes corresponding to the processing logics for summarizing the features.

21. The system of claim 19, wherein implementing the processing logics corresponding to the calculation nodes by the local machine or the cluster comprises:
compiling the processing logics corresponding to the calculation nodes into at least one executable file by the local machine or the cluster and operating the at least one executable file, and
wherein implementing the processing logics corresponding to the calculation nodes by the local machine or the cluster comprises at least one of following two steps: replacing a common subexpression in the processing logics with an intermediate variable in the process of compiling the processing logics corresponding to the calculation nodes into the executable file; and compiling part of processing logics that are closely related in operation and independent from other processing logics among the processing logics into the same executable file.

22. (canceled).

23. The system of claim 14, wherein the feature extraction scene is specified by a user or is determined automatically.

24. The system of claim 15, wherein the step of executing the generated execution plan in the distributed mode by the cluster comprises:
providing a list of candidate clusters to the user when the feature extraction scene is the offline feature extraction scene; and
executing the generated execution plan in the distributed mode by means of clusters selected by the user from the list.

25. The system of claim 20, wherein the processing logics for splicing the data table comprise processing logics for splicing the data table for the source fields of features.

26-27. (canceled).

28. A computer readable storage medium that stores a command, wherein when the command is operated by the at least one calculating device, the at least one calculating device is enabled to execute the method of claim 1 for uniform execution of feature extraction.
